(19) United States
(12) Patent Application Publication
(10) Pub. No.: US 2019/0358909 A1
(43) Pub. Date: Nov. 28, 2019

(54) METHOD FOR ASSEMBLING BY WELDING AT LEAST TWO COMPONENTS OF COMPOSITE MATERIAL AND ASSEMBLY OF COMPONENTS OF COMPOSITE MATERIAL OBTAINED IN THIS MANNER

(71) Applicant: Airbus Operations (S.A.S.), Toulouse (FR)

(72) Inventors: Richard Murillo, Toulouse (FR); Amaury Meyer, Colomiers (FR)

(21) Appl. No.: 16/419,436

(22) Filed: May 22, 2019

(30) Foreign Application Priority Data
May 24, 2018 (FR) 1854396

(51) Int. Cl. B29C 65/36; B29C 65/00

(52) U.S. Cl. CPC B29C 65/3672; B29C 66/721

(57) ABSTRACT

A method for assembling by welding at least two components of composite material includes positioning at least one connection layer of fibers so as to be interposed between the contact surfaces of the two components and/or positioned in the region of at least one contact surface of the two components, each connection layer having unidirectional fibers which are oriented in a direction different from the directions of the fibers of at least the fiber layers of the two components close to the contact surfaces. An induced electrical current is generated in a direction approximately parallel with the direction of the fibers of each connection layer. This method enables heating to be concentrated in the region of the contact surfaces. An assembly is disclosed of at least two components of composite material by carrying out the method.

### CROSS-REFERENCE TO RELATED APPLICATION

This application claims priority to French patent application number 18 54396 filed on May 24, 2018, the entire disclosure of which is incorporated by reference herein.

### TECHNICAL FIELD

The present application relates to a method for assembling by welding at least two components of composite material and an assembly of components of composite material obtained in this manner.

### BACKGROUND

A component of composite material comprises reinforcement fibers which are embedded in a matrix. According to one configuration, a component of composite material comprises several layers of carbon fibers which are superimposed and embedded in a thermoplastic resin.

For each of the layers, the fibers are unidirectional and oriented in one direction.

According to an embodiment which can be seen in FIG. 1, an assembly of two components 10, 12 of composite material comprises at least one interface 14 which has a first contact surface F10 of the first component 10 connected to a second contact surface F12 of the second component 12.

According to an operating method, an electromagnetic field, created in the environment of the interface 14, produces an induced electrical current which brings about heating. This heating brings about welding which connects the first and second contact surfaces F10, F12 of the two components.

In order to prevent damage to the layers of the components 10 and 12 adjacent to the interface 14 and not to bring about significant internal stresses in the components 10 and 12, it is necessary to concentrate the heating in the region of the interface 14.

According to a first operating method which can be seen in FIG. 1, a layer 16, which is also referred to as a susceptor and which has a conductivity greater than that of the carbon fibers, is interposed between the first and second contact surfaces F10, F12. By way of example, the layer 16 is a copper grid.

This first operating method is not entirely satisfactory since the presence of the layer 16 tends to reduce the mechanical characteristics of the connection between the components 10 and 12 of composite material. Furthermore, the layer 16 leads to the on-board mass being increased, whereas it does not have any post-assembly functionality other than the concentration of the heating during assembly.

According to a second operating method, the outer surfaces of the components 10 and 12 are cooled in order to prevent excessive heating outside an assembly zone which is centered relative to the outer surfaces. In accordance with the thicknesses of the components 10 and 12, however, the interface 14 may be offset with respect to this zone which is centered relative to the outer surfaces, as illustrated in FIG. 1. Consequently, this second operating method imposes significant sizing and geometric restrictions on the components 10 and 12.

### SUMMARY

An object of the disclosure herein is to overcome the disadvantages of the prior art.

To this end, the disclosure herein relates to a method for assembling by welding at least two components of composite material, the assembly comprising a first component which comprises at least a first contact surface, a second component which comprises at least a second contact surface and at least one interface in the region of which the first and second contact surfaces are connected, each component of composite material comprising several layers of fibers which are superimposed and embedded in a matrix, the method comprising a step of generating an induced electrical current.

According to the disclosure herein, the assembly method comprises a step of positioning at least one connection layer of fibers so as to be interposed between the first contact surface of the first component and the second contact surface of the second component and/or positioned in the region of at least one contact surface of the first and second contact surfaces, each connection layer having unidirectional fibers which are oriented in a direction different from the directions of the fibers of at least the fiber layers of the first and second components close to the first and second contact surfaces, the induced electrical current being generated in a direction approximately parallel with the direction of the fibers of each connection layer. In this manner, the Joule effect brought about by the electrical current appears mainly in the region of the connection layer(s).

This method enables a concentration of the heating in the region of the interface to be obtained, even if the interface is not positioned so as to be centered relative to the outer surfaces of the assembly, without having any need to interpose between the components a layer dedicated exclusively to the concentration of the heating. According to another advantage, the connection layer(s) contribute(s) to the mechanical characteristics of the assembly and have a post-assembly functionality.

According to a configuration, the fibers of each connection layer are oriented in a direction different from all the directions of the fibers of the fiber layers of the first and second components.

According to another feature, the fibers of at least one of the connection layers are impregnated with a resin.

According to an arrangement, the fibers of the first and second components form with a reference direction an angle in the order of 0°, 45°, 90° or 135° and the fibers of each connection layer form an angle with the reference direction in the order of 22.5°, 67.5°, 112.5° or 157.5°.

According to a first embodiment, a single connection layer is interposed between the first and second contact surfaces of the first and second components.

According to a second embodiment, a first connection layer is interposed between the first and second contact surfaces of the first and second components, a second connection layer and/or a third connection layer being positioned in the region of the first contact surface of the first component and/or of the second contact surface of the second component.

According to another embodiment, a connection layer is positioned in the region of the first contact surface of the first component and/or in the region of the second contact surface of the second component.

According to a first operating method, at least one connection layer is positioned just before the step of generating the induced electrical current.

According to a second operating method, at least one connection layer which is positioned in the region of a contact surface is integrated in the component before a step of consolidating the component.

The disclosure herein also relates to an assembly of at least two components of composite material obtained by carrying out the method according to any one of the above features.

### BRIEF DESCRIPTION OF THE FIGURES

Other features and advantages will be appreciated from the following description of the disclosure herein given purely by way of non-limiting example with reference to the appended drawings, in which:

FIG. 1 is a cross-section of an assembly of two components of composite material which illustrates an embodiment of the prior art;

FIG. 2 is a perspective view of an example of an assembly of two components of composite material;

FIG. 3 is a cross-section of an assembly of two components of composite material which illustrates a first embodiment of the disclosure herein;

FIG. 4 is a cross-section of an assembly of two components of composite material which illustrates a second embodiment of the disclosure herein, prior to assembly;

FIG. 5A is a partially broken-away view of a first contact surface of a first component of the assembly which can be seen in FIG. 4;

FIG. 5B is a view of a connection layer of the assembly which can be seen in FIG. 4; and

FIG. 5C is a partially broken-away view of a second contact surface of a second component of the assembly which can be seen in FIG. 4.

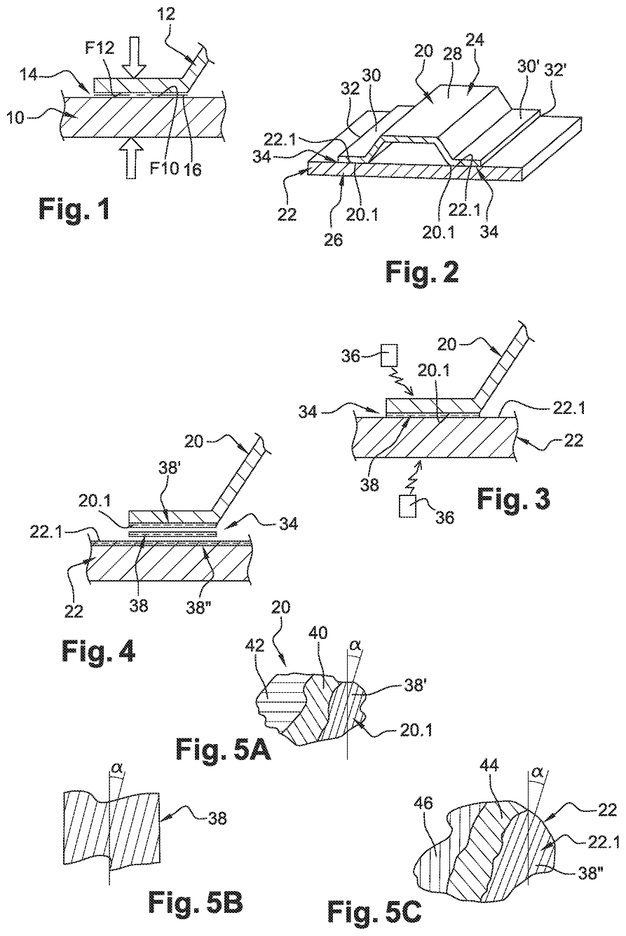

### DETAILED DESCRIPTION

FIGS. 2 through 4 show an assembly of two components 20 and 22 of composite material.

By way of example, as illustrated in FIG. 2, the component 20 is a reinforcement 24 with an omega-shaped cross-section and the component 22 is a panel 26.

The reinforcement 24 has a central portion 28 and first and second wings 30, 30′ which are arranged at one side and the other of the central portion 28 and which are connected to the panel 26. The reinforcement 24 is delimited by lateral edges 32, 32′.

Of course, the disclosure herein is not limited to this type of assembly.

Regardless of which embodiment is involved, the assembly comprises a first component 20 comprising at least a first contact surface 20.1, a second component 22 comprising at least a second contact surface 22.1 and at least one interface 34 in the region of which the first and second contact surfaces 20.1, 22.1 are connected, as illustrated in FIGS. 3 and 4.

Each component 20, 22 of composite material comprises several layers of reinforcement fibers which are superimposed and embedded in a matrix.

According to an embodiment, the reinforcement fibers are carbon fibers which are embedded in a thermoplastic resin.

For each of the layers, the fibers are unidirectional and oriented in a direction which forms a specific angle with a reference direction.

For each of the first and second components 20, 22, the number of layers and the orientation of their fibers are determined in accordance with the mechanical characteristics desired for the first and second components 20, 22. The first component 20 comprises superimposed layers, with each of the unidirectional fibers, the different layers of the first component 20 having fibers which are oriented in a first set of directions.

The second component 22 comprises superimposed layers, with each of the unidirectional fibers, the different layers of the second component 22 having fibers which are oriented in a second set of directions.

Each set comprises a plurality of directions, the fibers forming for each of the directions a specific angle with the reference direction. The first set of the first component 20 may comprise directions different from those of the second set of the second component 22.

For each set, the fibers of the first and second components 20, 22 form with the reference direction an angle in the order of 0°, 45°, 90° or 135°.

The first and second contact surfaces 20.1, 22.1 are connected by welding by generating heating as a result of an induced electrical current.

To this end, the assembly method comprises a step of generating an induced electrical current in the region of the interface 34 using an electromagnetic field generator 36.

According to a feature of the disclosure herein, the interface 34 comprises at least one connection layer 38 of conductive fibers interposed between the first contact surface 20.1 of the first component 20 and the second contact surface 22.1 of the second component 22 and/or positioned in the region of at least one contact surface from the first and second contact surfaces 20.1, 22.1.

The term “conductive fiber” is intended to be understood to mean that the fibers of the connection layer 38 have the capacity to convey an electrical current and therefore to generate heating by the Joule effect.

When the interface 34 comprises several connection layers 38, these different connection layers 38 have fibers which are all oriented in the same direction. The fibers of each connection layer 38 are of the same material as the fibers of the layers of the first and second components 20, 22.

Each connection layer 38 comprises unidirectional fibers which are oriented in a direction different from the directions of the fibers of at least the layers of fibers of the first and second components 20, 22 close to the first and second contact surfaces 20.1 and 22.1. The term “close” is intended to be understood to mean the first ten layers of the first and second components 20, 22 from the first and second contact surfaces 20.1, 22.1.

According to a configuration, the fibers of each connection layer 38 are oriented in a direction different from all the directions of the fibers of the fiber layers of the first and second components 20, 22.

By way of example, the fibers of each connection layer 38 form an angle in the order of 22.5°, 67.5°, 112.5° or 157.5° with the reference direction.

The electromagnetic field generator 36 is configured to generate an induced electrical current in a direction approximately parallel with the direction of the fibers of each connection layer 38.

Consequently, taking into account the orientation of the fibers of the connection layer(s) 38 and the orientation of the induced current produced by the electromagnetic field generator 36, the heating generated by the induced current will be substantially produced in the region of the connection layer(s) 38. This arrangement enables a concentration of the heating to be obtained in the region of the interface 34. According to another advantage, this/these connection layer(s) 38 contribute(s) to the structural properties of the assembly.

According to another feature, the fibers of at least one of the connection layers 38 are impregnated with a resin.

In addition, during the welding, the first and second components 20 and 22 are subjected to compression forces which are intended to press the first and second contact surfaces 20.1, 20.2.

In this manner, during the welding, the heating will soften or deconsolidate the resin which will creep as a result of the compression forces and fill any gaps which may be present between the first and second components 20, 22. This arrangement contributes to reducing the porosity of the assembly.

According to an embodiment, the fibers of the connection layer(s) are of the same material as the fibers of the first and second components 20 and 22. According to an embodiment, the fibers of the connection layer(s) are of carbon. In this manner, in contrast to the prior art, the connection layer(s) 38 contribute(s) to the mechanical characteristics of the assembly and have a functionality post assembly.

When the fibers of the connection layer(s) 38 are impregnated with resin, they are impregnated with a thermoplastic resin of the same type as that of at least one of the first and second components 20, 22.

According to a first embodiment which can be seen in FIG. 3, the interface 34 comprises a single connection layer 38 which is interposed between the first and second contact surfaces 20.1, 22.1 of the first and second components 20 and 22.

According to another embodiment which can be seen in FIGS. 4, 5A through 5C, the interface 34 comprises a first connection layer 38 which is interposed between the first and second contact surfaces 20.1, 22.1 of the first and second components 20 and 22 (which can be seen in FIG. 5B), a second connection layer 38′ which is positioned in the region of the first contact surface 20.1 of the first component 20 and a third connection layer 38″ positioned in the region of the second contact surface 22.1 of the second component 22. The fibers of the different connection layers 38, 38′, 38″ all form an angle α with the longitudinal direction.

In FIG. 5A, the first three layers of the first component 20 from the first contact surface 20.1 have been illustrated, that is to say, the second connection layer 38′, a first layer 40 having fibers which are oriented in a first direction different from that of the fibers of the second connection layer 38′ and a second layer 42 having fibers which are oriented in a second direction different from that of the fibers of the second connection layer 38′.

In FIG. 5C, the first three layers of the second component 22 from the second contact surface 22.1 have been illustrated, that is to say, the third connection layer 38″, a third layer 44 having fibers which are oriented in a third direction different from that of the fibers of the third connection layer 38″ and a fourth layer 46 having fibers which are oriented in a fourth direction different from that of the fibers of the third connection layer 38″.

According to another embodiment, the interface 34 comprises a first connection layer 38 which is interposed between the first and second contact surfaces 20.1, 22.1 of the first and second components 20 and 22 and a second connection layer 38′ or 38″ positioned only in the region of one of the two contact surfaces 20.1, 22.2.

According to another embodiment, the interface 34 does not comprise any connection layer 38 interposed between the first and second contact surfaces 20.1, 22.2 of the first and second components 20, 22. The interface 34 comprises a connection layer 38′ positioned in the region of the first contact surface 20.1 of the first component 20 and/or a connection layer 38″ positioned in the region of the second contact surface 22.1 of the second component 22.

According to a first operating method, at least one connection layer 38, 38′ 38″ is positioned just before the step of generating the induced electrical current.

According to another operating method, at least one connection layer 38′, 38″ positioned in the region of a contact surface 20.1 or 22.2 is integrated in the component 20, 22 before a step of consolidating the component 20, 22.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assembling by welding at least two components of composite material, the assembly comprising a first component comprising at least a first contact surface, a second component comprising at least a second contact surface and at least one interface in a region of which the first and second contact surfaces are connected, each component of composite material comprising several layers of fibers which are superimposed and embedded in a matrix, the method comprising:
generating an induced electrical current, wherein the assembly method comprises a step of positioning at least one connection layer of conductive fibers to be interposed between the first contact surface of the first component and the second contact surface of the second component and/or positioned in the region of at least one contact surface of the first and second contact surfaces, each connection layer having unidirectional fibers which are oriented in a direction different from directions of the fibers of at least the fiber layers of the first and second components close to the first and second contact surfaces, and wherein the induced electrical current is generated in a direction approximately parallel with the direction of the fibers of each connection layer.

2. The method for assembling by welding at least two components of composite material according to claim 1, wherein the fibers of each connection layer are oriented in a direction different from all directions of the fibers of the fiber layers of the first and second components.

3. The method for assembling by welding at least two components of composite material according to claim 1, wherein the fibers of at least one of the connection layers are impregnated with a resin.

4. The method for assembling by welding at least two components of composite material according to claim 1, wherein the fibers of the first and second components form with a reference direction an angle in the order of 0°, 45°, 90° or 135° and wherein the fibers of each connection layer form an angle with the reference direction in an order of 22.5°, 67.5°, 112.5° or 157.5°.

5. The method for assembling by welding at least two components of composite material according to claim 1, wherein a single connection layer is interposed between the first and second contact surfaces of the first and second components.

6. The method for assembling by welding at least two components of composite material according to claim 1, wherein a first connection layer is interposed between the first and second contact surfaces of the first and second components and wherein a second connection layer and/or a third connection layer is/are positioned in the region of the first contact surface of the first component and/or of the second contact surface of the second component.

7. The method for assembling by welding at least two components of composite material according to claim 1, wherein a connection layer is positioned in the region of the first contact surface of the first component and/or in the region of the second contact surface of the second component.

8. The method for assembling by welding at least two components of composite material according to claim 1, wherein at least one connection layer is positioned just before generating the induced electrical current.

9. The method for assembling by welding at least two components of composite material according to claim 1, wherein at least one connection layer which is positioned in the region of a contact surface is integrated in the component before a step of consolidating the component.

10. An assembly of at least two components of composite material obtained by carrying out the method according to claim 1.
